(19) United States
(12) Patent Application Publication
(10) Pub. No.: US 2008/0282154 A1
(43) Pub. Date: Nov. 13, 2008

(54) METHOD AND APPARATUS FOR IMPROVED TEXT INPUT

(76) Inventor: Mikko A. Nurmi, Tampere (FI)

Correspondence Address: PERMAN & GREEN, 425 POST ROAD, FAIRFIELD, CT, 06824, US

(21) Appl. No.: 11/530,691

(22) Filed: Sep. 11, 2006

(51) Int. Cl. G06F 17/21; G06F 17/20

(52) U.S. Cl. 715/261; 704/8

(57) ABSTRACT

A method for providing a combined set of proposed words from a predictive text engine, as well as a module, an apparatus, a system and a computer readable medium. Generally, according to the method, a number of key input actuations is received via e.g. a keypad. Then, a first set of proposed words based upon the key input actuations is determined, using a predictive text engine, and shown to the user. Upon the determination of the first set, a speech input device and a speech recognition engine is activated and a speech input is received. Based on the speech input, using a the speech recognition engine, a second set of proposed words is determined. Finally, the first and second set of proposed words are combined into the combined set of proposed words.

### TECHNICAL FIELD

The disclosed embodiments generally relate to communication and more particularly to a method, a module, an apparatus, a system and a computer-readable medium for enhanced text input.

### BACKGROUND

Many mobile terminal users have discovered the possibility to write and send text messages, such as SMS and e-mail. Some mobile terminal users have also discovered the possibility to connect to the Internet via their mobile terminals.

The development from a mobile telephone for making and receiving telephone calls to a mobile terminal for all kinds of communication and information services has generated a great demand for quick and user friendly text input solutions.

Generally, in order to write a text message quickly, a well suited keyboard is an advantage. Typically, such a keyboard has a number of keys corresponding to letters and numbers, e.g. 26 keys from “A” to “Z” and 10 keys from “0” to “9”, and a number of control keys, such as a “Shift” button for switching between small letters and capital letters.

However, due to the lack of space on a mobile terminal, as well as a desire to keep the production cost reasonable, one button per letter is in some cases not a possible alternative. Due to this, a number of text input solutions for unambiguous keyboards, i.e. keyboards where each key corresponds to several letters or numbers, has been developed.

One simple text input solution for unambiguous keyboards is the multitap solution. In this solution, every button corresponds to a number of letters. For instance, in order to write an “a” in a text input mode, the button is pressed once, in order to write a “b” the button is pressed twice quickly, and “c” three times quickly. The text input solution is easy to handle, but it requires a lot of key input actuations.

Another type of text input solutions for unambiguous keyboards are the predictive text input solutions, such as the well-known T9 solution. In a predictive text input solution, only one key input actuation per button is required. Based on the key input actuations, a number of proposed words are determined. The proposed words are presented to the user, e.g. in a list, and among these proposed words the user chooses the one he had in mind.

If the user would like to change a word afterwards, the word may be activated, e.g. by using a cursor, whereupon the proposed words will be shown again and the user is given a possibility to choose another one of the proposed words.

Still another type of text input solution is presented in the UK patent application GB 2 406 476. This application discloses a mobile telephone comprising a predictive text system as well as a speech recognition unit. The speech recognition unit is adapted to receive a word spoken by the user. Thereafter, a key pad is utilised to confine the speech recognition vocabulary to words that begin with a letter corresponding to the key input.

Although a number of text input solutions for unambiguous keyboards have been developed, the demand for quick and user friendly text input still remains.

### SUMMARY

One embodiment provides an efficient solution for text input using a predictive text analysis combined with speech analysis.

The disclosed embodiments are based on the understanding that the predictive text analysis may be performed by a predictive text engine, which may be defined as a computer implemented algorithm for determining possible words from a number of key input actuations of an unambiguous keypad of e.g. a mobile terminal, e.g. the well known predictive text engine is the so-called T9.

Further, the disclosed embodiments is based on the understanding that the speech analysis can be performed by a speech recognition engine, which may be defined as a computer implemented algorithm for determining possible words from an audio file containing speech, or a audio data stream containing speech.

In a first aspect, one embodiment comprises by a method for providing a combined set of proposed words from a predictive text engine, comprising receiving a number of key input actuations, determining, using a predictive text engine, a first set of proposed words based upon said key input actuations, displaying said first set of proposed words,

activating a speech input device and a speech recognition engine, receiving a speech input through said activated speech input device, determining a second set of proposed words based upon said speech input using said speech recognition engine, and combining said first set of proposed words and said second set of proposed words into said combined set of proposed words.

An advantage of combining the predictive text analysis with the speech analysis is that less time is needed to write a text using an unambiguous keyboard.

Another advantage is that less power is consumed, since the speech input device and the speech recognition engine is automatically activated when needed.

Still an advantage is that an easily handled text input process is achieved, since the speech input device and the speech recognition engine is automatically activated when needed.

In this first aspect said combined set of proposed words may equal the union of said first and second set of proposed words.

An advantage of this is that even though one of the key input actuations is a mistake, which means that the word in demand is not within the first set of proposed words, the speech analysis may find the word in demand and hence add this to the second set of proposed words.

Further, in this first aspect said combined set may be listed in a probability order.

An advantage of this is that the most likely words may be emphasized when being presented to the user, which implies that text input process may take less time. For instance, such emphasizing may be to place the most likely words of the combined set in the first places in a list containing the words of the combined set.

In this first aspect said second set of proposed words may be limited to be a subset of said first set of proposed words.

An advantage of this is that the only the words found by the predictive text engine are considered by the speech recognition engine, which means that less alternatives are considered, implying less time and less power consumption.

In this first aspect said second set of proposed words may be determined based upon a speech analysis probability, an overall language specific occurrence frequency, a user language specific occurrence frequency, or any combination thereof.

An advantage of this is that, e.g. in a situation where the speech recognition engine indicates two words with the same probability, the most common word of these two may be considered as the most likely. This implies a more robust solution.

In this first aspect a significance value for said speech analysis probability, a significance value for an overall language specific occurrence frequency and/or a significance value for a user language specific occurrence frequency may be user configurable.

An advantage of this is that the user may configure the method according to his preferences.

In this first aspect said combined set of proposed words may comprise one most likely word.

An advantage of this is that the most probable word may be chosen automatically, which implies a faster text input process.

The method of the above mentioned first aspect may further comprise: estimating the amount of background noise, determining if said amount of background noise is within an acceptance range, if said amount of background noise is outside said acceptance range, setting said first set of proposed words as said combined set of proposed words.

An advantage of this is that in a situation where there are too much noise to be able to make a reliable speech analysis, this situation will be detected and the speech input device and the speech recognition engine will hence not be activated, thus saving energy.

The method of the above mentioned first aspect may further comprise: upon receiving a key input actuation corresponding to one of the words of said first set of proposed words, setting said one of the words of said first set of proposed words as said combined set of proposed words.

An advantage of this is that when the user is in a situation where it is inappropriate to speak, or the user for some other reason does not want to speak out the word, one of the words of the first set of proposed words may be chosen with the help of a key input actuation.

The method of the above mentioned first aspect may further comprise: selecting the one of the words as an input word.

An advantage of this is that as soon as a word corresponding to the first set of proposed words has been chosen by the user, this word may be transmitted as an input word to the current application, e.g. an SMS editor.

The method of the above mentioned first aspect may further comprise deactivating said speech input device and said speech recognition engine upon said determination.

An advantage of this is that as soon as the speech input device and the speech recognition engine are not needed anymore, they will be deactivated. This implies a more power efficient solution.

In a second aspect one embodiment provides a module comprising a predictive text engine configured to determine a first set of proposed words, a speech recognition engine configured to determine a second set of proposed words, a controller configured to activate said speech recognition engine upon the determination of said first set of proposed words, and a text-speech combiner configured to determine a combined set of proposed words based upon said first and second set of proposed words.

An advantage of this is that the controller may automatically activate the speech input device and the speech recognition engine when they are needed. This implies a more power efficient module.

This second aspect of the disclosed embodiment may further comprise a timer configured to determine whether a speech input is made within a predetermined period of time.

An advantage of this is that if no speak is detected for the predetermined period of time, the speech input device and the speech recognition engine may be switched off. This implies a more power efficient module.

This second aspect may further comprise a noise estimator configured to determine whether sound conditions provided to said speech recognition engine are within an acceptance range.

An advantage of this is that in a situation where there are too much noise to be able to make a reliable speech analysis, this situation will be detected and the speech input device and the speech recognition engine will hence not be activated.

In this second aspect the controller may further be configured to deactivate said speech recognition engine upon a key input actuation corresponding to one of the words of said combined set of proposed words.

An advantage of this is that when the user selects one of the words of the first set of proposed words by pressing a key, a selection has been made and there are no further need for the speech input device and the speech recognition engine. Therefore, by deactivating the speech input device and the speech recognition device, a more power efficient module is achieved.

In this second aspect of the disclosed embodiments said controller may be configured to determine the likelihood for the words of said combined set of proposed words.

An advantage of this is that the user may first be presented to the most likely words, which means that text input process may take less time.

In a third aspect, one embodiment provides an apparatus comprising a text input device, a predictive text engine configured to determine a first set of proposed words, a display, a speech input device, a speech recognition engine configured to determine a second set of proposed words, a controller configured to activate said speech input device and said speech recognition engine upon the determination of said first set of proposed words, and a text-speech combiner configured to determine a combined set of proposed words based upon said first and second set of proposed words.

An advantage of this is that the speech input device and the speech recognition engine may automatically be activated when they are needed. This implies a power efficient apparatus.

The third aspect of the disclosed embodiments may further comprise a timer configured to determine whether a speech input is made within a predetermined period of time.

An advantage of this is that if no speak is detected, the speech input device and the speech recognition engine may be switched off. This implies a more power efficient apparatus.

The third aspect of the disclosed embodiments may further comprise a noise estimator configured to determine whether sound conditions provided by said speech input device are within an acceptance range.

An advantage of this is that in a situation where there are too much noise to be able to make a reliable speech analysis, this situation will be detected and the speech input device and the speech recognition engine will hence not be activated, thus saving energy.

In this third aspect of the disclosed embodiment said controller may further be configured to deactivate said speech input device and said speech recognition engine upon a key input actuation corresponding to one of the words of said combined set of proposed words.

An advantage of this is that as soon as the speech input device and the speech recognition engine are not needed anymore they will be deactivated. This implies a more power efficient solution.

In this third aspect of the disclosed embodiment said controller may further be configured to determine the likelihood for the words of said combined set of proposed words.

An advantage of this is that the user may first be presented to the most likely words, which means that text input process may take less time.

In a fourth aspect, one embodiment provides a system comprising a text handling device, said text handling device comprising a text input device and a text information sender, a speech handling device, said speech handling device comprising an activation signal receiver,

a speech input device and a speech information sender, a processing device, said processing device comprising a text information receiver, a predictive text engine configured to determine a first set of proposed words, an activation signal sender, a speech information receiver, a speech recognition engine, a controller configured to activate said speech input device and said speech recognition engine upon the determination of said first set of proposed words, a text-speech combiner configured to determine a combined set of proposed words based upon said first and second set of proposed words, and a word set sender, and a display device, said display device comprising a word set receiver and a display.

An advantage of this is that the speech input device and the speech recognition engine may automatically be activated when they are needed. This implies a more power efficient system.

Another advantage is that the process may be divided on several devices, which e.g. means that the processing may be made by a computer having high processing capacity.

In this fourth aspect of the disclosed embodiment said controller in said processing device may further be configured to activate said speech input device in said speech handling device.

An advantage of this is that the speech input device may automatically be activated when it is needed. This implies a more power efficient apparatus.

In this fourth aspect of the disclosed embodiments said text handling device and said display device are comprised within a visual user interface device.

An advantage of this is that the text handling is made easily. Such a visual user interface device may be a personal digital assistant (PDA) connected to a headset and a computer.

In this fourth aspect of the disclosed embodiment said text handling device, said speech handling device, and said display device may be comprised within a user interface device.

Such a user interface device may e.g. be a mobile terminal connected to a computer.

In this fourth aspect of the disclosed embodiment said speech handling device may further comprise a timer configured to determine whether a speech input is made within a predetermined period of time.

An advantage of this is that if no speak is detected, the speech input device and the speech recognition engine may be switched off. This implies a more power efficient apparatus.

In this fourth aspect of the disclosed embodiment said speech handling device may further comprise a noise estimator configured to determine whether sound conditions provided by said speech input device are within an acceptance range.

An advantage of this is that in a situation where there are too much noise to be able to make a reliable speech analysis, this situation may be detected and the speech input device and the speech recognition engine will hence not be activated, thus saving energy.

In this fourth aspect of the disclosed embodiment said controller in said processing device may further be configured to deactivate said speech input device and said speech recognition engine upon the reception of a key input actuation, from said text input device in said text handling device, corresponding to one of the words of said combined set of proposed words.

An advantage of this is that as soon as the speech input device and the speech recognition engine are not needed anymore they will be deactivated. This implies a more power efficient solution.

In this fourth aspect of the disclosed embodiments said controller in said processing device may further be configured to determine the probability for the words of said combined set of proposed words.

An advantage of this is that the user may first be presented to the most likely words, which means that text input process may take less time.

In a fifth aspect, one embodiment provides a computer-readable medium having computer-executable components comprising instructions for receiving a number of key input actuations, determining, using a predictive text engine, a first set of proposed words based upon said number of key input actuations, displaying said first set of proposed words, activating a speech input device and a speech recognition engine, receiving a speech input through said activated speech input device,

determining a second set of proposed words based upon said speech input using said speech recognition engine, and combining said first set of proposed words and said second set of proposed words into said combined set of proposed words.

The fifth aspect of the disclosed embodiments may further comprise instructions for deactivating said speech input device and said speech recognition engine upon said determination.

In this fifth aspect of the disclosed embodiments said second set of proposed words may be determined based upon a speech analysis probability, an overall language specific occurrence frequency, a user language specific occurrence frequency, or any combination thereof.

The fifth aspect of the disclosed embodiments may further comprise instructions for estimating the amount of background noise, determining if said amount of background noise is within an acceptance range, if said amount of background noise is outside said acceptance range, setting said first set of proposed words as said combined set of words.

The fifth aspect of the disclosed embodiments may further comprise instructions for upon receiving a key input actuation corresponding to one of the words of said first set of proposed words, setting said one of the words of said first set as said combined set of proposed words.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The above, as well as additional features and advantages of the disclosed embodiments will be better understood through the following illustrative and non-limiting detailed description of preferred embodiments of the present invention, with reference to the appended drawings, wherein:

FIG. 1 is a flow chart illustrating the general concept of the disclosed embodiments.

FIG. 2 schematically illustrates a method according to one embodiment.

FIG. 3 schematically illustrates a method according to one embodiment, wherein noise is considered.

FIG. 4 schematically illustrates a module according to one embodiment.

FIG. 5 schematically illustrates an apparatus according to one embodiment.

FIG. 6 schematically illustrates a system according to one embodiment.

FIG. 7 schematically illustrates an embodiment of the system.

FIG. 8 schematically illustrates another embodiment of the system.

### DETAILED DESCRIPTION OF THE PREFERRED EMBODIMENT

The disclosed embodiments generally relate to an efficient text input process. The text input process may be applied for a device having an unambiguous keypad, a speech input device and a processor.

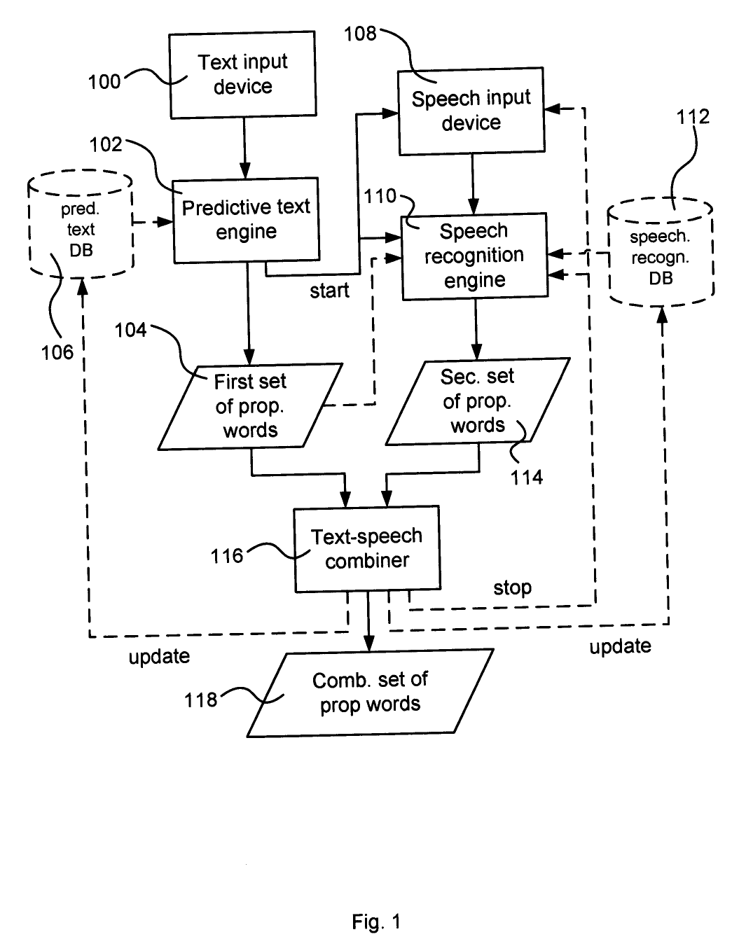

In FIG. 1, a flow chart illustrating the general concept of the disclosed embodiments is shown.

A set of key input actuations is input via a text input device 100. The text input device 100 may be an unambiguous keypad placed on a device, such as a mobile terminal.

The set of key input actuations is thereafter transferred to a predictive text engine 102, which transforms the set of key input actuations into a first set of proposed words 104. A well-known predictive text engine 102 is the T9 engine, which is included in many mobile terminals of today. Optionally, an external predictive text database 106 may be connected to the predictive text engine 102.

Upon the determination of the first set of proposed words 104, an activation signal (start) may be transferred from the predictive text engine 102 to a speech input device 108, such as a microphone, and to a speech recognition engine 110. After having received the activation signal, the speech input device 108 and the speech recognition device 110 are activated.

Optionally, the activation signal may only be sent to the speech input device 108 and the speech recognition engine 110 if the first set of words 104 contains more than one word.

In order to improve the user interaction, a text message may be shown on a display indicating that the speech input device 108 and the speech recognition engine 110 are activated.

After the user has spoken the word to be determined in the speech input device 108, the speech input corresponding to the spoken word is transferred to the speech recognition engine 110.

The speech recognition engine 110 analyzes the speech input with the help of speech recognition algorithms, which results in a speech analysis probability for a number of words.

In order to make a better selection, the occurrence frequency, i.e. how common the word is, for the number of words may be taken into account. The occurrence frequency may be an overall language specific occurrence frequency or a user language specific occurrence frequency, or a combination of them both. If the combination is chosen, a significance value may be set for the overall language specific occurrence frequency, another significance value may be set for the user language specific occurrence frequency, and still another significance value for the probability determined by the speech analysis. The significance values may be user configurable or adaptive.

Optionally, the databases utilised by the speech recognition engine 110 may be comprised within an external speech recognition database 112 connected to the speech recognition engine 110.

Alternatively, in order to improve the speech analysis, the first set of proposed words 104 may be transferred to the speech recognition engine 110. In this way the speech analysis may be limited to the first set of words 104, which means that less words have to be considered. This means, in turn, that the probability for correct speech recognition is higher, and that the process may take less time and computing power, since less words are considered.

A second set of proposed words 114 is output from the speech recognition engine 110. This second set 114 and the first set of proposed words 104 output from the predictive text engine 102 are input to a text-speech combiner 116.

In the text-speech combiner 116, the first and second set of proposed words are combined into a combined set of proposed words 118. This combined set of proposed words 118 may be shown to the user in the form of a list. Further, the proposed words may be sorted with falling likelihood, i.e. the most probable word is placed in the first place in the list, the second most probable word is placed in the second place in the list, and so on. The first position of the list, or in other words the most probable word, may be the default position of the cursor, which means that only one button press confirming the choice is required to select the most probable word.

Optionally, update information may be sent to the predictive text database 106 and the speech recognition database 112 after having combined the first set of proposed words 104 and the second proposed words 114 in the text-speech combiner 116.

Further, a deactivation signal (stop) may optionally be transferred from the text-speech combiner 116 to the speech input device 108 and/or the speech recognition engine 110. In this way, the speech input device 108 and the speech recognition engine 110 may be automatically switched on as soon as the speech input to be used to determine the second set of proposed words 114 is needed, and automatically switched off as soon as the combined set of proposed words 118 is determined by the text-speech combiner 116.

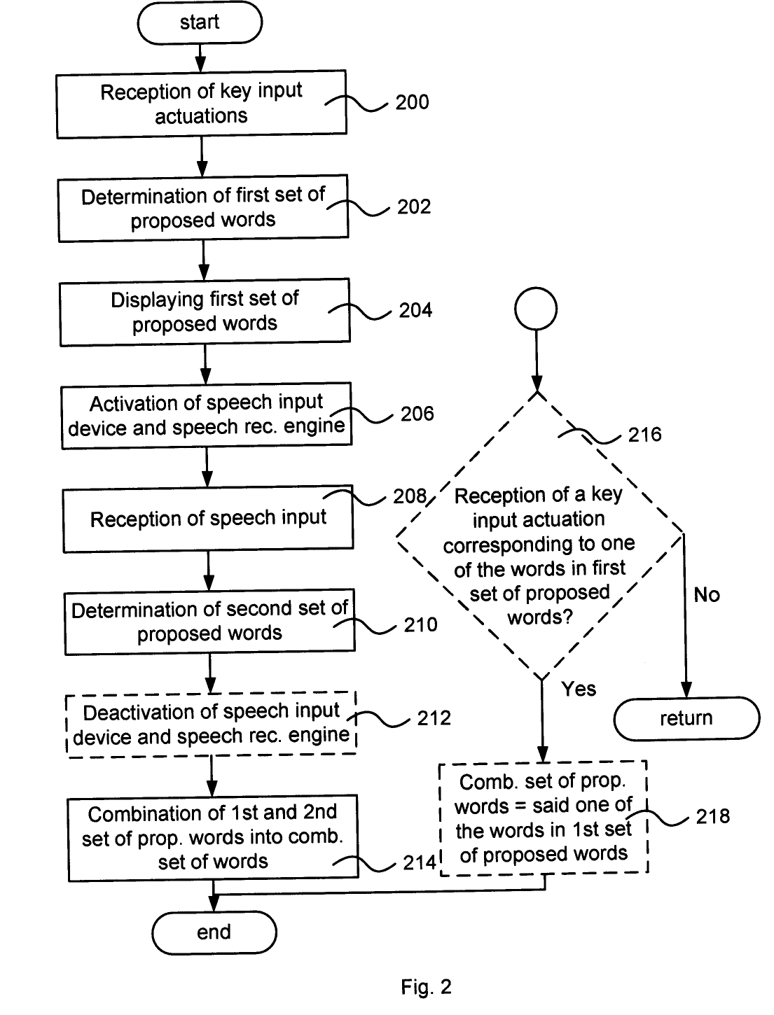

In FIG. 2, a method for providing a combined set of proposed words is illustrated in more detail.

In a step 200, a number of key input actuations are received.

Thereafter, in a step 202, a first set of proposed words are determined by using a predictive text engine.

The determined first set of words are then displayed, step 204.

As soon as the first set of words are determined the speech input device and the speech recognition engine may be activated, step 206. Optionally, since the speech input device is used before the speech recognition engine, the speech input device may be activated before the speech recognition engine.

Next, when the speech input device and the speech recognition engine are activated, a speech input is received, step 208.

Based on the received speech input, a second set of proposed words is determined using the speech recognition engine, step 210.

Optionally, after having determined the second set of proposed words, the speech input device as well as the speech recognition engine may be deactivated, step 212.

Finally, in step 214, the first and second set of proposed words may be combined into a combined set of words.

Optionally, the procedure described above may be partly replaced by another process. Namely, if a key input actuation corresponding to one of the words in the first set of proposed words is received, step 216, the procedure may be interrupted and the combined set of proposed words may be set to be the one of the words, step 218. However, if no key input actuation corresponding to the first set of proposed words is received, the procedure may be as described above. This parallel process may be started as soon as the first set of proposed words is determined and may continue until the combined set of proposed words is determined, step 214.

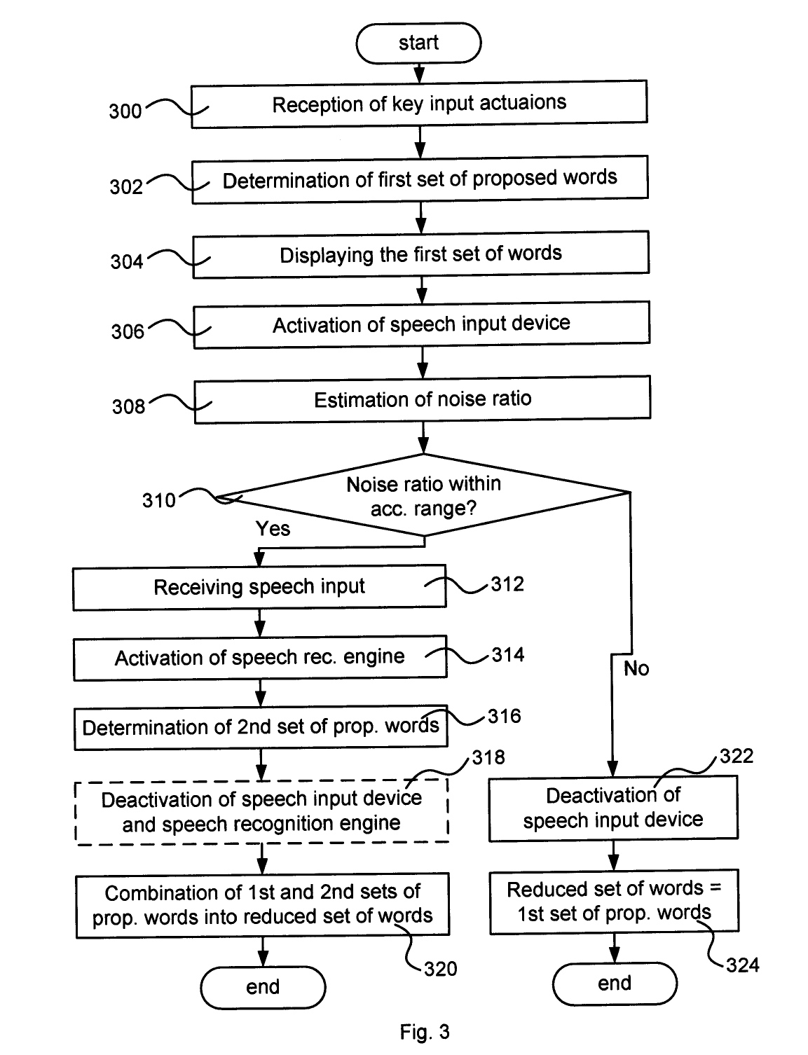

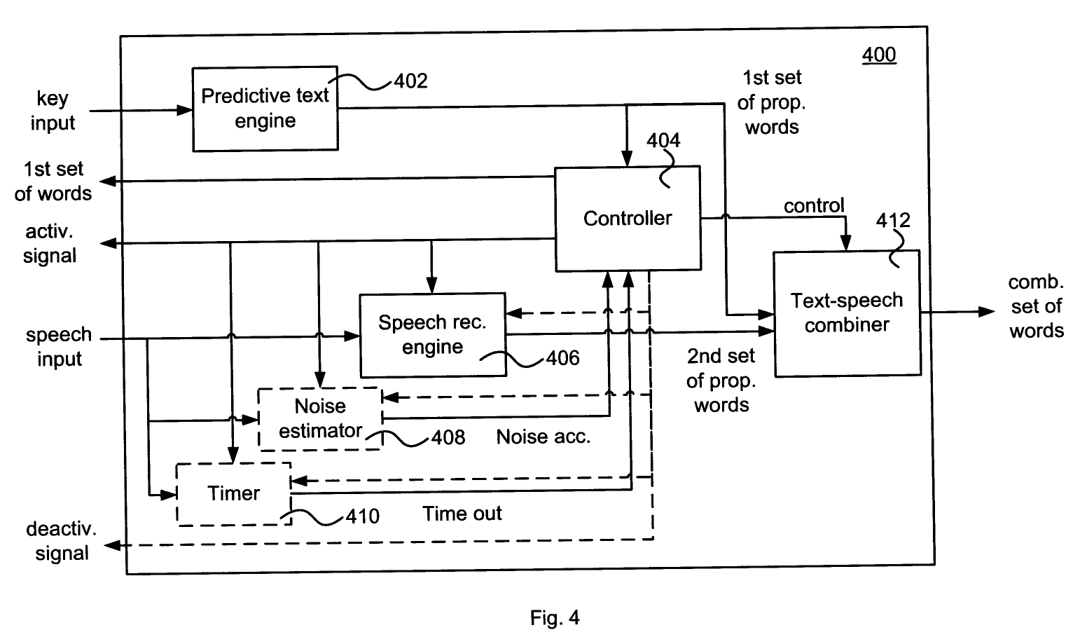

FIG. 3 illustrates a method for providing a combined set of proposed words, wherein the occurrence of noise is considered. The method illustrated in FIG. 3 may be combined with the method illustrated in FIG. 4.

As is described above, a number of key input actuations is received, step 300, a first set of proposed words is determined, step 302, and the first set of proposed words is displayed, step 304.

Then, the speech input device is activated, step 306, and a noise ratio, corresponding to the amount of background noise, is estimated, step 308.

In step 310, it is determined whether the estimated noise ratio is within an acceptance range or not.

If the background noise is within the acceptance range a speech input is received, step 312, and the speech recognition engine is activated, step 314.

Thereafter, a second set of proposed words is determined, step 316.

Optionally, in step 318, the speech input device and the speech recognition engine may be deactivated.

Finally, in the same way as is described above, the first and second sets of proposed words are combined into a combined set of words, step 320.

However, if the noise ratio is determined to be outside the acceptance range, step 310, the speech input device may be deactivated, step 322.

Since no speech input is available due to background noise outside the acceptance range, no second set of proposed words may be determined. Therefore, the combined set of proposed words is set to be the first set of proposed words, step 324.

Optionally, an indication may be sent to the user that the noise level is too high in order to make a proper speech analysis. Such an indication may be a display message shown on a display, a sound, a vibration, etc.

FIG. 4 schematically illustrates a module 400 according to an embodiment of the present invention. It should be noted that parts not contributing to the core of the invention are left out in order not to obscure the features of the present invention. Further, the module 400 may be a software module, a hardware module, or a combination thereof, such as an FPGA-processor.

The module 400 comprises a predictive text engine 402, a controller 404, a speech recognition engine 406, optionally a noise estimator 408, optionally a timer 410 and a text/speech combiner 412.

For instance, the predictive text engine 402 may comprise a processor, a memory containing a database, an input communication port and an output communication port (not shown). In operation, a number of key input actuations is received via the input communication port, whereupon the received key input actuations is transformed by the processor and the memory to a first set of proposed words, and, then, the first set of proposed words is output via the output communication port. As can be readily understood by a man skilled in the art, the predictive text engine may be implemented as a software module as well.

The first set of proposed words is transferred from the predictive text engine 402 to the controller 404 and to the text-speech combiner 412.

The controller 404 may be a microcontroller, comprising a processor, a memory and communication ports (not shown), or a software implemented module. Upon reception of the first set of proposed words, an activation signal is transmitted from the controller 404 to an external device, such as an external speech input device. Further, an activation signal is transmitted to the speech recognition engine 406, and optionally to the noise estimator 408 as well as the timer 410. Optionally, a deactivation signal may be transmitted from the controller 404 to the speech recognition engine 406, optionally to the noise estimator 408 and the timer 410 as well, and, optionally, to an external device.

Moreover, a control signal (control) may be transmitted from the controller 404 to the text-speech combiner. For instance, the control signal may indicate the conditions for how the first and second set of proposed words are to be combined.

The speech recognition engine 406 may be a microcontroller, comprising a processor, a memory and communication ports (not shown), or a software implemented module.

Upon reception of the activation signal, if the speech recognition engine 406 is implemented as a microcontroller, the speech recognition engine 406 may be designed to go from a low power state to a high power state, such as from an idle state to an operation state. In this way a more power efficient module may be achieved.

The speech recognition engine 406 is designed to receive a speech input from an external device, such as an external microphone. Upon the reception of the speech input, a second set of proposed words is determined based on speech analysis algorithms.

Optionally, the speech recognition engine 406 may be designed to receive a deactivation signal. Upon reception of the deactivation signal, the speech recognition engine 406 may be designed to go from a high power state to a low power state, such as from an operation state to an idle state.

The noise estimator 408 may be a microcontroller or a software implemented module. It is designed to receive the speech input and to transmit a noise acceptance signal to the controller 404. The noise acceptance signal may be a signal indicating whether the noise level is within or outside an acceptance range.

In an embodiment, the speech input is transmitted to the noise estimator 408 before being transmitted to the speech recognition engine 406.

Further, the noise estimator 408 may also be designed to switch power states as an activation signal or deactivation signal is received in accordance with the speech recognition engine 406.

The timer 410 may be a microcontroller or a software implemented module. The speech input is transmitted to the timer 410. If no speech is detected within a predetermined period of time, a time out signal is transmitted to the controller 404.

Further, the timer 410 may also be designed to switch power states as an activation signal or deactivation signal is received in accordance with the speech recognition engine 406.

Finally, the text-speech combiner 412 may be a microcontroller or a software implemented module. The purpose of the text-speech combiner 412 is to combine the first set of proposed words and the second set of proposed words into a combined set of proposed words.

The combination may be the union of the first and second set of proposed words, i.e. all possible words, or the intersection between the first and the second set of proposed words, i.e. the words present in both the first and second set of proposed words.

Further, the text-speech combiner may sort the words in the combined set of proposed words according to likelihood. For instance, the most likely word may be emphasized, such as being placed in the first place in a list containing the words of the combined set.

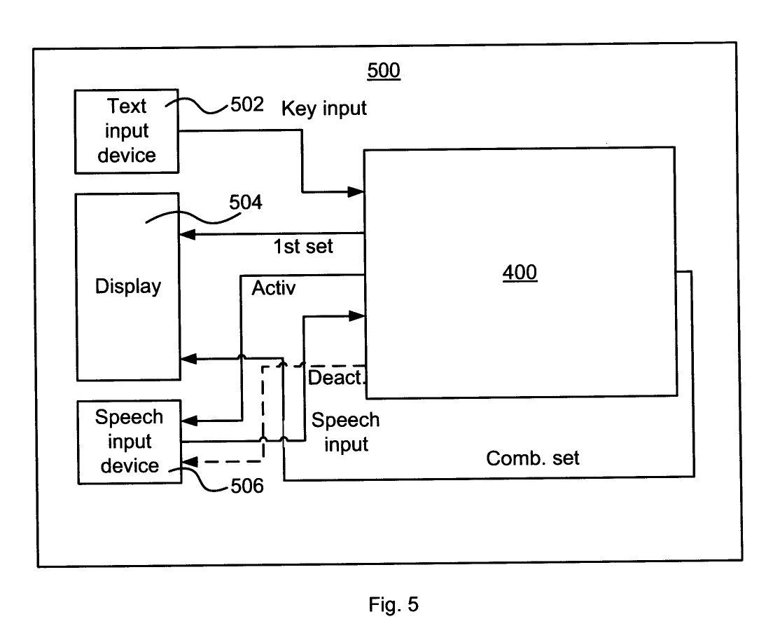

FIG. 5 schematically illustrates an apparatus 500 providing efficient text input comprising the module 400.

In addition, the apparatus 500 may comprise a text input device 502, a display 504 and a speech input device 506.

The text input device 502 may be a keypad, and is utilised to transmit key input actuations to the module 400.

The display 504 is adapted to receive the first set of proposed words determined by the module 400 and to visually show this set of words for the user, as well as the combined set of proposed words when this set has been determined by the module 400.

The speech input device 506 may be a microphone that is adapted to receive an activation signal from the module 400, and, based upon the activation signal, switch from a low power state to a high power state, such as from an idle state to an operation state. Further, the speech input device 505 is adapted to receive a speech input from the user and transmit the input to the module 400. Optionally, the speech input device 506 may also be adapted to receive a deactivation signal from the module 400 and, based upon the deactivation signal, switch from a low power state to a high power state, such as from an idle state to an operation state.

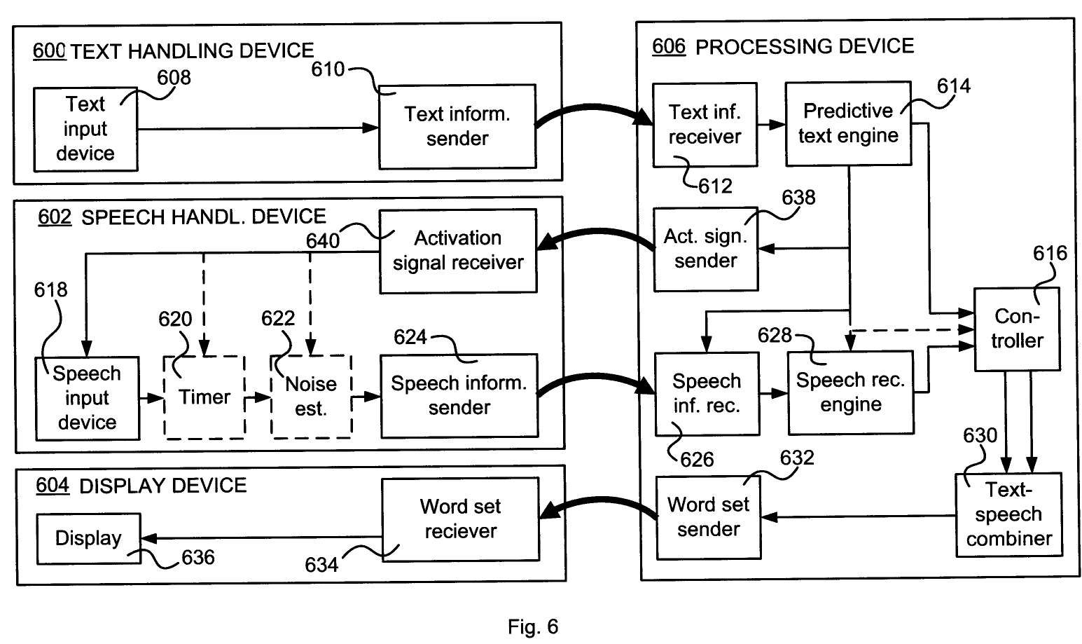

FIG. 6 illustrates a system comprising a text handling device 600, such as a PDA, a speech handling device 602, such as a microphone, a display device, such as a monitor, and a processing device 606, such as computer.

The text handling device 600 may comprise a text input device 608, such as a keypad, and a text information sender 610, such as a BlueTooth™ transceiver.

The speech handling device 602 may comprise a speech input device 618, such as a microphone, optionally a timer 620, optionally a noise estimator 622, a speech information sender 624 and an activation signal receiver 640. When the activation signal is received by the activation signal receiver 640, the signal is passed to the speech input device, and optionally to the timer 620 and the noise estimator 622, whereupon the these may be switched from a low power state to a high power state, such as from an idle state to an operation state.

The display device 604 may comprise a display 636 and a word set receiver 634.

The processing device 606 may comprise a text information receiver adapted to receive the key input actuations transmitted from the text handling device 600.

Further, the processing device 606 may comprise a predictive text engine 614, similar to the one illustrated in FIG. 4. When having determined a first set of proposed words using the predictive text engine 614, an activation signal may be transmitted by using an activation signal sender 638 to the speech handling device 602. The activation signal may also be transmitted to a speech information receiver 626, a speech recognition engine 628, and, optionally, to a controller 616.

The speech information receiver 626 are adapted to receive speech input from the speech information sender 624 in the speech handling device 602. After having received the speech input, the speech input is transmitted to the speech recognition engine 628, which is similar to the one illustrated in FIG. 4.

The first set of proposed words, determined by the predictive text engine 614, and the second set of proposed words, determined by the speech recognition engine 628, are transmitted to a controller 616. The controller 616 may pass the first and second set of proposed words to a text-speech combiner 630, which is similar to the one illustrated in FIG. 4. Alternatively, the first and second set of proposed words are transmitted directly to the text-speech combiner 630, without passing the controller 616.

The combined set of proposed words, which is determined by the text-speech combiner 630, is transmitted to a word set sender 632. The word set sender 632 is adapted to transmit the combined set of words to the word set receiver 634 placed in the display device 604.

The functionality of the system illustrated in FIG. 6 is generally the same as the functionality of the apparatus illustrated in FIG. 4. However, in the system illustrated in FIG. 6, the operation is divided on several devices.

The communication between the different devices illustrated in FIG. 6 may be achieved by short radio communication, such as BlueTooth™, or WLAN. If the processing device 606 is a computer placed far away, the communication may be made using GSM or UMTS.

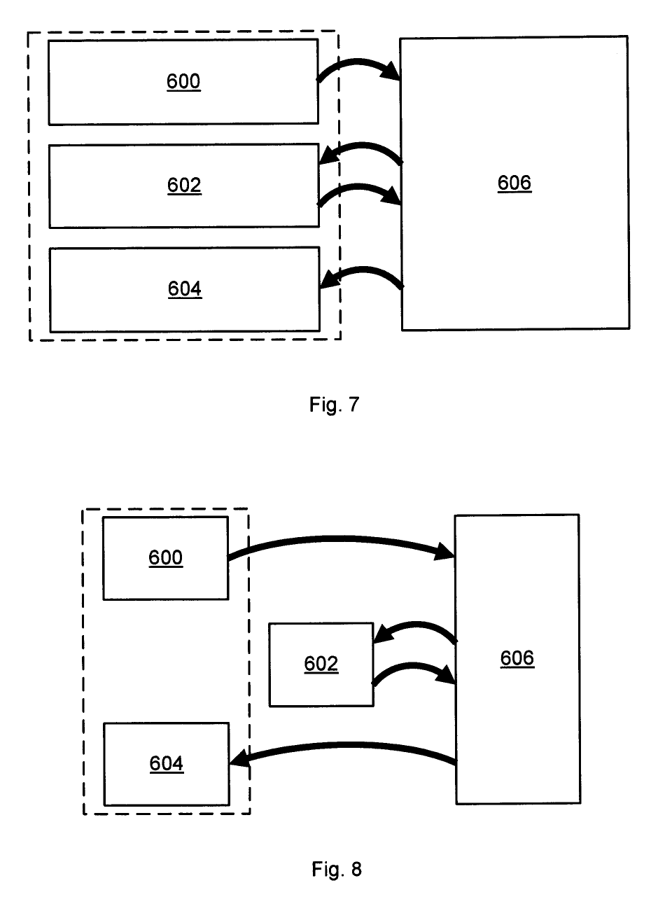

FIG. 7 illustrates a system, as illustrated in FIG. 6, wherein the text handling device 600, the speech handling device 602 and the display device 604 are comprised in one and the same apparatus. Such an apparatus may be a mobile terminal.

FIG. 8 illustrates a system, as illustrated in FIG. 6, wherein the text handling device 600 and the display device 604 are comprised in a first apparatus and the speech handling device 602 is comprised in a second apparatus. Such a first apparatus may be a mobile terminal and such a second apparatus may be a headset. Alternatively, the first apparatus may be a map display placed in a car and the second apparatus may be a headset.

The invention has mainly been described above with reference to a few embodiments. However, as is readily appreciated by a person skilled in the art, other embodiments than the ones disclosed above are equally possible within the scope of the invention, as defined by the appended patent claims.

1. A method for providing a combined set of proposed words from a predictive text engine, comprising
receiving a number of key input actuations,
determining, using a predictive text engine, a first set of proposed words based upon said key input actuations,
displaying said first set of proposed words,
activating a speech input device and a speech recognition engine,
receiving a speech input through said activated speech input device,
determining a second set of proposed words based upon said speech input using said speech recognition engine, and
combining said first set of proposed words and said second set of proposed words into said combined set of proposed words.

2. The method according to claim 1, wherein said combined set of proposed words equals the union of said first and second set of proposed words.

3. The method according to claim 1, wherein the words within said combined set are listed in a probability order.

4. The method according to claim 1, wherein said second set of proposed words is limited to be a subset of said first set of proposed words.

5. The method according to claim 1, wherein said second set of proposed words is determined based upon a speech analysis probability, an overall language specific occurrence frequency, a user language specific occurrence frequency, or any combination thereof.

6. The method according to claim 5, wherein a significance value for said speech analysis probability, a significance value for an overall language specific occurrence frequency and/or a significance value for a user language specific occurrence frequency are user configurable.

7. The method according to claim 1, wherein said combined set of proposed words comprises one most likely word.

8. The method according to claim 1, further comprising
estimating the amount of background noise,
determining if said amount of background noise is within an acceptance range,
if said amount of background noise is outside said acceptance range, setting said first set of proposed words as said combined set of proposed words.

9. The method according to claim 1, further comprising upon receiving a key input actuation corresponding to one of the words of said first set of proposed words, setting said one of the words of said first set of proposed words as said combined set of proposed words.

10. The method according to claim 9, further comprising selecting the one of the words as an input word.

11. The method according to claim 1, further comprising
deactivating said speech input device and said speech recognition engine upon said determination.

12. A module comprising
a predictive text engine configured to determine a first set of proposed words,
a speech recognition engine configured to determine a second set of proposed words,
a controller configured to activate said speech recognition engine upon the determination of said first set of proposed words, and
a text-speech combiner configured to determine a combined set of proposed words based upon said first and second set of proposed words.

13. The module according to claim 12, further comprising
a timer configured to determine whether a speech input is made within a predetermined period of time.

14. The module according to claim 12, further comprising
a noise estimator configured to determine whether sound conditions provided to said speech recognition engine are within an acceptance range.

15. The module according to claim 12, wherein said controller is further configured to deactivate said speech recognition engine upon a key input actuation corresponding to one of the words of said combined set of proposed words.

16. The module according to claim 12, said controller is configured to determine the likelihood for the words of said combined set of proposed words.

17. An apparatus comprising
a text input device,
a predictive text engine configured to determine a first set of proposed words,
a display,
a speech input device,
a speech recognition engine configured to determine a second set of proposed words,
a controller configured to activate said speech input device and said speech recognition engine upon the determination of said first set of proposed words, and
a text-speech combiner configured to determine a combined set of proposed words based upon said first and second set of proposed words.

18. The apparatus according to claim 17, further comprising
a timer configured to determine whether a speech input is made within a predetermined period of time.

19. The apparatus according to claim 17, further comprising
a noise estimator configured to determine whether sound conditions provided by said speech input device are within an acceptance range.

20. The apparatus according to claim 17, wherein said controller is further configured to deactivate said speech input device and said speech recognition engine upon a key input actuation corresponding to one of the words of said combined set of proposed words.

21. The apparatus according to claim 17, said controller is further configured to determine the likelihood for the words of said combined set of proposed words.

22. A system comprising
a text handling device,
said text handling device comprising
a text input device and
a text information sender,
a speech handling device,
said speech handling device comprising
an activation signal receiver,
a speech input device and
a speech information sender,
a processing device,
said processing device comprising
a text information receiver,
a predictive text engine configured to determine a first set of proposed words,
an activation signal sender,
a speech information receiver,
a speech recognition engine,
a controller configured to activate said speech input device and said speech recognition engine upon the determination of said first set of proposed words,
a text-speech combiner configured to determine a combined set of proposed words based upon said first and second set of proposed words, and
a word set sender,
and a display device,
said display device comprising
a word set receiver and
a display.

23. The system according to claim 22, wherein said controller in said processing device is further configured to activate said speech input device in said speech handling device.

24. The system according to claim 22, wherein said text handling device and said display device are comprised within a visual user interface device.

25. The system according to claim 22, wherein said text handling device, said speech handling device, and said display device are comprised within a user interface device.

26. The system according to claim 22, wherein said speech handling device further comprises
a timer configured to determine whether a speech input is made within a predetermined period of time.

27. The system according to claim 22, wherein said speech handling device further comprises
a noise estimator configured to determine whether sound conditions provided by said speech input device are within an acceptance range.

28. The system according to claim 22, wherein said controller in said processing device is further configured to deactivate said speech input device and said speech recognition engine upon the reception of a key input actuation, from said text input device in said text handling device, corresponding to one of the words of said combined set of proposed words.

29. The system according to claim 22, wherein said controller in said processing device is further configured to determine the probability for the words of said combined set of proposed words.

30. A computer-readable medium having computer-executable components comprising instructions for
receiving a number of key input actuations,
determining, using a predictive text engine, a first set of proposed words based upon said number of key input actuations,
displaying said first set of proposed words,
activating a speech input device and a speech recognition engine,
receiving a speech input through said activated speech input device,
determining a second set of proposed words based upon said speech input using said speech recognition engine, and
combining said first set of proposed words and said second set of proposed words into said combined set of proposed words.

31. The computer-readable medium according to claim 30, further comprising instructions for
deactivating said speech input device and said speech recognition engine upon said determination.

32. The computer-readable medium according to claim 30, wherein said second set of proposed words is determined based upon a speech analysis probability, an overall language specific occurrence frequency, a user language specific occurrence frequency, or any combination thereof.

33. The computer-readable medium according to claim 30, further comprising instructions for
estimating the amount of background noise,
determining if said amount of background noise is within an acceptance range,
if said amount of background noise is outside said acceptance range, setting said first set of proposed words as said combined set of words.

34. The computer-readable medium according to claim 30, further comprising instructions for upon receiving a key input actuation corresponding to one of the words of said first set of proposed words, setting said one of the words of said first set as said combined set of proposed words.
